(19) United States
(12) Patent Application Publication
(10) Pub. No.: US 2025/0094714 A1
(43) Pub. Date: Mar. 20, 2025

(54) STRUCTURED DIALOGUE SEGMENTATION AND STATE TRACKING

(71) Applicant: Microsoft Technology Licensing, LLC, Redmond, WA (US)

(72) Inventors: Tara Lynn SAFAVI, Seattle, WA (US); Sarkar Snigdha Sarathi DAS, State College, PA (US); Chirag SHAH, Kenmore, WA (US); Jennifer Lynay NEVILLE, West Lafayette, IN (US); Mengting WAN, Bellevue, WA (US); Longqi YANG, Issaquah, WA (US); Reid Marlow ANDERSEN, Los Angeles, CA (US); Georg Ludwig Wilhelm BUSCHER, San Jose, CA (US)

(73) Assignee: Microsoft Technology Licensing, LLC, Redmond, WA (US)

(21) Appl. No.: 18/368,491

(22) Filed: Sep. 14, 2023

(51) Int. Cl. G06F 40/289; G06F 16/332; G06F 40/35

(52) U.S. Cl. CPC G06F 40/289; G06F 16/3329; G06F 40/35

(57) ABSTRACT

Systems and methods for open-domain dialogue segmentation and state tracking are provided. In particular, a computing device may obtain and analyze a dialogue in near real-time, generate a structured prompt template for a state prediction model based on the dialogue, and generate a structured output using the state prediction model based on the structured prompt template. The structured output includes a turn summary and state labels for each dialogue turn.

### BACKGROUND

Task-oriented dialogue systems are designed to assist users to achieve specific goals. To do so, traditional dialogue systems often use dialogue state tracking (DST) to track user preferences and intents in the course of conversation by filling in multiple pre-defined slots to complete the tasks. For example, a website for an airline may utilize a chat bot that will track the dialogue with a user to try and figure out the intent of the user (such as booking a flight, canceling a flight, changing a seat assignment or the like). Accurately tracking the state is foundational for successful dialogue systems, as dialogue state information can help such systems appropriately route backend skills, improve task detection and completion rates, and infer user interests for better personalization. These dialogue systems further track user preferences and intents in the course of conversation by filling in multiple pre-defined slots to complete the tasks.

However, a new type of dialogue system has emerged in the era of Large Language Models (LLMs). LLMs are capable of conversing across an arbitrarily large set of topics and can be integrated with a wide variety of task-oriented plugins, in addition to supporting social (e.g., task-less) conversation. In LLM-driven conversations, traditional DST is not useful as the scope of the conversation is too broad and often will switch from one topic to another. Additionally, real-world dialogues often exhibit extensive discourse that extend over multiple conversational turns in order to more fully examine or explore diverse topics. This prolonged conversational nature makes it highly challenging to track contextual coherence.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with at least one example of the present disclosure, a method for open-domain dialogue segmentation and state tracking is provided. The method includes obtaining and analyzing a dialogue in near real-time, the dialogue being an open-domain dialogue, generating a structured prompt template for a state prediction model based on the dialogue, and generating a structured output using the state prediction model based on the structured prompt template, the structured output including a turn summary and state labels for each dialogue turn.

In accordance with at least one example of the present disclosure, a computing device for open-domain dialogue segmentation and state tracking is provided. The computing device may include a processor and a memory having a plurality of instructions stored thereon that, when executed by the processor, causes the computing device to obtain and analyze a dialogue in near real-time, the dialogue being an open-domain dialogue, generate a structured prompt template for a state prediction model based on the dialogue, and generate a structured output using the state prediction model based on the structured prompt template. The structured output includes a turn summary and state labels for each dialogue turn, and the state labels for each dialogue turn includes a segment boundary label, a user intent label, and a dialogue domain label for each dialogue turn.

In accordance with at least one example of the present disclosure, a non-transitory computer-readable medium storing instructions for open-domain dialogue segmentation and state tracking is provided. The instructions when executed by one or more processors of a computing device, cause the computing device to obtain and analyze a dialogue in near real-time, the dialogue being an open-domain dialogue, generate a structured prompt template for a state prediction model based on the dialogue, and generate a structured output using the state prediction model based on the structured prompt template. The structured output includes a turn summary and state labels for each dialogue turn. The state labels for each dialogue turn includes a segment boundary label, a user intent label, and a dialogue domain label for each dialogue turn. The structured prompt template includes labeling instructions, a structured valid state list, and a turn-by-turn structured dialogue in a structured representation format.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment in which a dialogue tracking tool may be implemented in accordance with examples of the present disclosure;

FIGS. 2A and 2B depict a flowchart of an example method of tracking dialogue states in an open-domain dialogue in accordance with examples of the present disclosure;

FIGS. 2C and 2D depict a flowchart of an example method of segmenting an open-domain dialogue and determining dialogue states based on the dialogue segmentation in accordance with examples of the present disclosure;

FIG. 3 illustrates an example open-domain, open-ended, LLM-driven dialogue between a user and an artificial intelligent (AI) agent that extends over multiple dialogue turns to discuss diverse topics in accordance with examples of the present disclosure;

FIG. 4 is a block diagram illustrating an exemplary overview of tracking dialogue states in an open-domain dialogue between a user and an AI agent in accordance with examples of the present disclosure;

FIGS. 5A-5F are experimental results of a structured prompting approach for open-domain dialogue segmentation and state tracking in accordance with examples of the present disclosure;

FIGS. 6A and 6B illustrate overviews of an example generative machine learning model that may be used in accordance with examples of the present disclosure;

FIG. 7 is a block diagram illustrating example physical components of a computing device with which aspects of the disclosure may be practiced;

FIG. 8 is a simplified block diagram of a computing device with which aspects of the present disclosure may be practiced; and

FIG. 9 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As stated above, task-oriented dialogue systems are designed to assist users to achieve specific goals. To do so, traditional task-oriented dialogue systems often use dialogue state tracking (DST) to track user preferences and intents in the course of conversation by filling in multiple pre-defined slots to complete the tasks.

However, the emergence of new types of dialogue systems in the era of Large Language Models (LLMs) has created open-domain LLM-based chat or dialogue systems, such as ChatGPT and Bing Chat. LLM-based chat systems are capable of conversing across an arbitrarily large set of topics and can be integrated with a wide variety of task-oriented plugins, in addition to supporting social (e.g., task-less) conversation. For example, LLM-based chat systems can accomplish many user tasks out-of-the-box that previously required specialized systems, for example, code generation, essay writing, and question answering. As such, in LLM-driven conversations, traditional DST and the use of pre-defined slots is not designed to capture the breadth of domains and intents that may be explored in an LLM-driven conversation.

In accordance with examples of the present disclosure, a dialogue tracking tool is described that provides analysis and tagging frameworks for open-domain dialogue using a structured prompting approach. Open-domain dialogues often contain extensive back-and-forth between parties (e.g., clarification, negotiation, etc.) in order to pursue a single intent or topic, and contexts may shift multiple times within a single dialogue among unrelated intents and/or topics. As such, the dialogue tracking tool is configured to track states (e.g., segment boundary labels, user intent labels, and dialogue domain labels) at a turn-by-turn level in open-domain, multi-intent dialogue. To do so, the dialogue tracking tool generates a structured prompt template for a state prediction model for determining state labels for each segment and accurately tracking long dialogue context at a turn-by-turn level. The structured prompt template includes labeling instructions, the structured valid state list, and the turn-by-turn structured dialogue. It should be appreciated that the structured prompt template does not include any example input-output pairs (e.g., zero-shot).

In accordance with examples of the present disclosure, the dialogue tracking tool generates the labeling instructions, which includes segmentation instructions and pre-analytical recollection (PAR) instructions. The segmentation instructions are generated to instruct the state prediction model to segment the dialogue into one or more segments that are contextually related. In other words, each dialogue segment is contiguous subsequences of utterances that are topically related (e.g., related to a single intent or topic). Additionally, the segmentation instructions are generated to instruct the state prediction model to use the same user intent and dialogue domain for dialogue turns within the same dialogue segment. Without the segmentation instructions, the state prediction model may over-index on content of a dialogue turn without considering the fuller preceding context, which may lead to conflicting intent and domain label prediction between dialogue turns within a coherent single topic segment of the dialogue.

In accordance with examples of the present disclosure, the PAR instructions are generated to instruct the state prediction model to summarize each dialogue turn before determining state labels of the corresponding dialogue turn. Additionally, the PAR instructions are generated to instruct the state prediction model to refer back to the prior contextual segments when determining state labels. In other words, grounding each output state prediction on the content of the corresponding dialogue turn and/or the prior contextual segments allows the state prediction model to accurately track long dialogue context without forgetting or hallucination.

In accordance with examples of the present disclosure, the structured valid state list is generated by formatting into a structured representation (e.g., a hierarchical Extensible Markup Language (XML)-structured format) based on valid state values associated with the dialogue. For example, the valid state values include one or more valid segment boundary labels, one or more valid intent labels, and one or more valid domain labels related to the dialogue. Additionally, the turn-by-turn structured dialogue is generated by converting the dialogue into a structured representation of dialogue at a turn level. In other words, the turn-by-turn structured representation of the dialogue includes a structured representation of each dialogue turn of the dialogue.

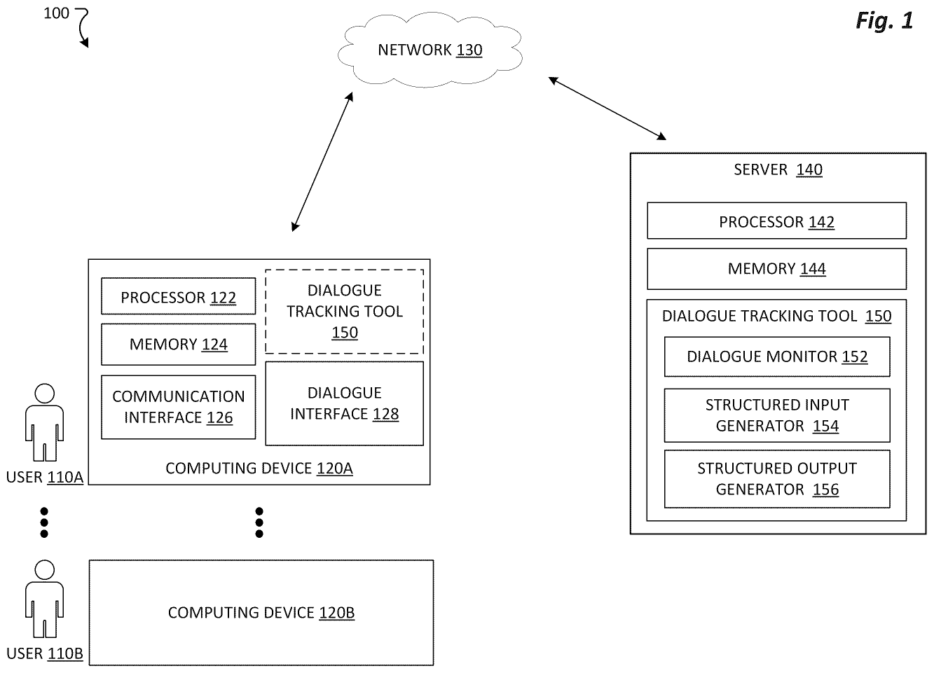

FIG. 1 depicts a block diagram of an example of an operating environment 100 in which a dialogue tracking tool may be implemented in accordance with examples of the present disclosure. To do so, the operating environment 100 includes a computing device 120 associated with the user 110. The operating environment 100 may further include one or more remote devices, such as a productivity platform server 140, that are communicatively coupled to the computing device 120 via a network 130. The network 130 may include any kind of computing network including, without limitation, a wired or wireless local area network (LAN), a wired or wireless wide area network (WAN), and/or the Internet.

The computing device 120 includes a processor 122, a memory 124, and a communication interface 126. In some embodiments, the dialogue tracking tool 150 may be executed on the computing device 120. Additionally, the computing device 120 may be, but is not limited to, a computer, a notebook, a laptop, a mobile device, a smartphone, a tablet, a portable device, a wearable device, or any other suitable computing device that is capable of communicating with the server 140. The sever 140 includes a processor 142, a memory 144, and a dialogue tracking tool 150. The sever 140 may be any suitable computing device that is capable of executing the dialogue tracking tool 150.

The dialogue tracking tool 150 is configured to track dialogue states in open-domain dialogues using a state prediction model. It should be appreciated that the dialogue tracking tool 150 allows tracking of state labels of a dialogue in near real-time. Near real-time means that the dialogue tracking tool 150 obtains or receives utterances of the dialogue occurring in real-time as quickly as the network 130 will allow. To do so, the dialogue tracking tool 150 further includes a dialogue monitor 152, a structured input generator 156, and a structured output generator 158.

The dialogue monitor 152 is configured to monitor or otherwise obtain a dialogue between at least two parties. The dialogue is a conversation between two or more parties. The party may be a human or an artificial intelligence (AI) agent. For example, the dialogue may be open-domain, open-ended conversations.

The structured input generator 154 is configured to generate a structured prompt template for a state prediction model. It should be appreciated that the state prediction model is one or more large language models (LLMs) (e.g., GPT4, KOSMOS). The structured prompt template includes labeling instructions, a structured valid state list, and a turn-by-turn structured dialogue.

The structured input generator 154 is configured to generate the labeling instructions for a state prediction model. The labeling instructions include segmentation instructions and pre-analytical recollection (PAR) instructions. To do so, the structured input generator 154 is configured to generate the segmentation instructions for instructing the state prediction model to segment the dialogue into one or more segments that are contextually related. Each dialogue segment is contiguous subsequences of utterances that are topically related (e.g., related to a single intent or topic). The structured input generator 154 is configured to generate the segmentation instructions for instructing the state prediction model to identify a segment boundary when no topical relation between a dialogue turn and its preceding context could be identified. Additionally, the structured input generator 154 is configured to generate the segmentation instructions for instructing the state prediction model to use the same user intent and dialogue domain for dialogue turns within the same dialogue segment. Without the segmentation instructions, the state prediction model may over-index on content of a dialogue turn without considering the fuller preceding context, which may lead to conflicting intent and domain label prediction between dialogue turns within a coherent single topic segment of the dialogue.

Additionally, the structured input generator 154 is configured to generate the PAR instructions for instructing the state prediction model to summarize each dialogue turn before determining state labels of the corresponding dialogue turn. The structured input generator 154 is configured to generate the PAR instructions for instructing the state prediction model to refer back to the prior contextual segments when determining state labels. Instructing the state prediction model to ground each output state prediction on the content of the corresponding dialogue turn and/or the prior contextual segments allows the state prediction model to accurately track long dialogue context without forgetting or hallucination.

The structured input generator 154 is further configured to generate the structured valid state list based on valid state values associated with the dialogue. For example, the valid state values include one or more valid segment boundary labels, one or more valid intent labels, and one or more valid domain labels related to the dialogue. The structured input generator 154 is configured to format the valid state values into a structured representation (e.g., a hierarchical Extensible Markup Language (XML)-structured format).

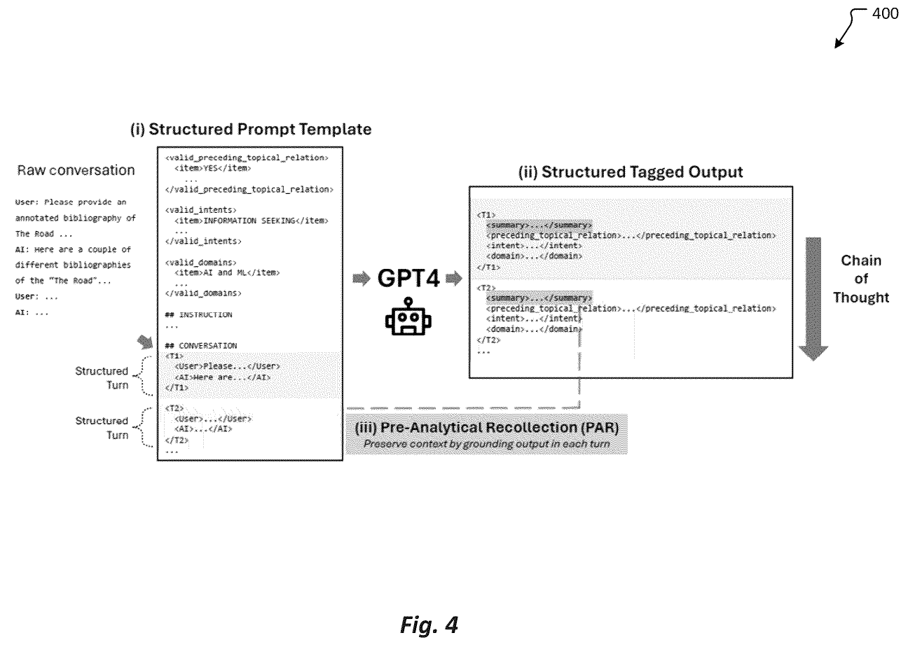

The structured input generator 154 is configured to generate a turn-by-turn structured dialogue by converting the dialogue into a structured representation of dialogue at a turn level. In other words, the turn-by-turn structured representation of the dialogue includes a structured representation of each dialogue turn of the dialogue. For example, as illustrated in FIG. 4, an exemplary dialogue between a user and an AI agent is converted into a structured representation in a hierarchical XML-structured format, where dialogue turns are marked with turn id number <T{id}> . . . </T{id}> numbered from 1 to N and each dialogue turn includes nested user and agent turns marked with appropriate tags (e.g., <user> . . . </user> and <agent> . . . </agent>). It should be appreciated that the dialogue may be between multiple users or between one or more users and one or more AI agents.

The structured input generator 154 is configured to generate the structured prompt template for the state prediction model based on labeling instructions, the structured valid state list, and the turn-by-turn structured dialogue. It should be appreciated that the structured prompt template does not include any example input-output pairs (e.g., zero-shot). For example, as illustrated in FIG. 4, the structured prompt template may be generated by appending the turn-by-turn structured dialogue to the structured valid state list and the labeling instructions. In an example shown in FIG. 4, the structured prompt template is in a hierarchical XML-structured format, which is human-readable and flexible while still being highly structured. The structured prompt template is inputted to the state prediction model (e.g., GPT4), which provide a structured output representation. The structured input and output representation helps provide coherence and consistency to the inputs and outputs, allowing the state prediction model to accurately determine and tag the conversation state.

The structured output generator 156 is configured to generates a structured output using the state prediction model based on the structured prompt template. The structured output generator 156 is configured to generates a structured output in the same structured format (e.g., a hierarchical XML-structured format) as the structured prompt template using the state prediction model. The structured output includes a turn summary and state labels (e.g., segment boundary, user intent, and dialogue domain labels) for each dialogue turn. For example, the segmentary boundary label may be a binary label, and the intent and domain labels may be categorical labels. For example, as illustrated in FIG. 4, the structured output is generated in a hierarchical XML-structured format in which each dialogue turn form 1 to N comprises an XML tree <T{id}> . . . </T{id}> and nested XML tags within it. The labels of the nested tags (e.g., <preceding_topical_relation> . . . </preceding_topical_relation>, <intent> . . . </intent>, and <domain> . . . </domain>) represent the segment boundaries and slots of interest, and each value between opening and closing tags represent the one or more predicted value. It should be appreciated that the structured outputs generated in a bounded well-defined structured format are more likely to be aligned with labeling instructions than free-form texts and are easier to parse, which reduces postprocessing requirements.

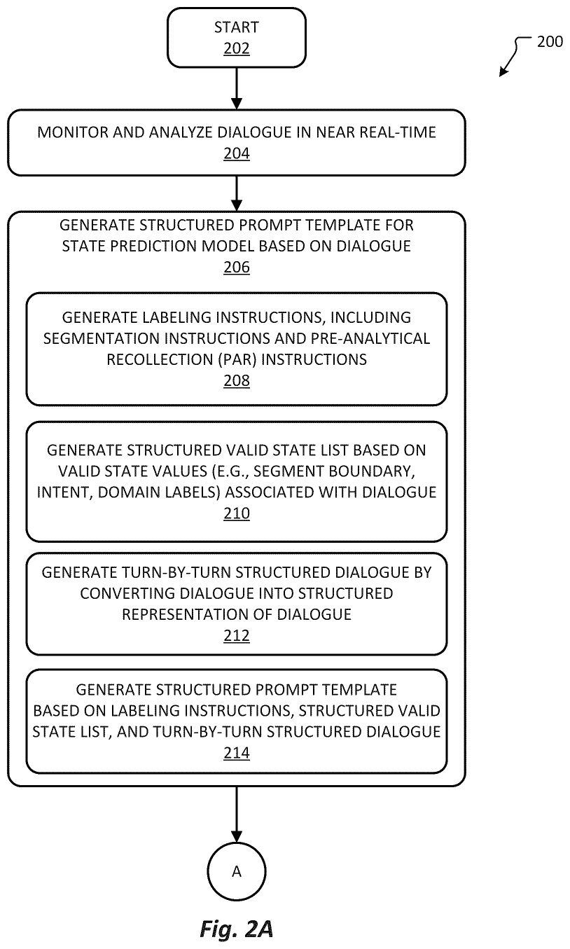

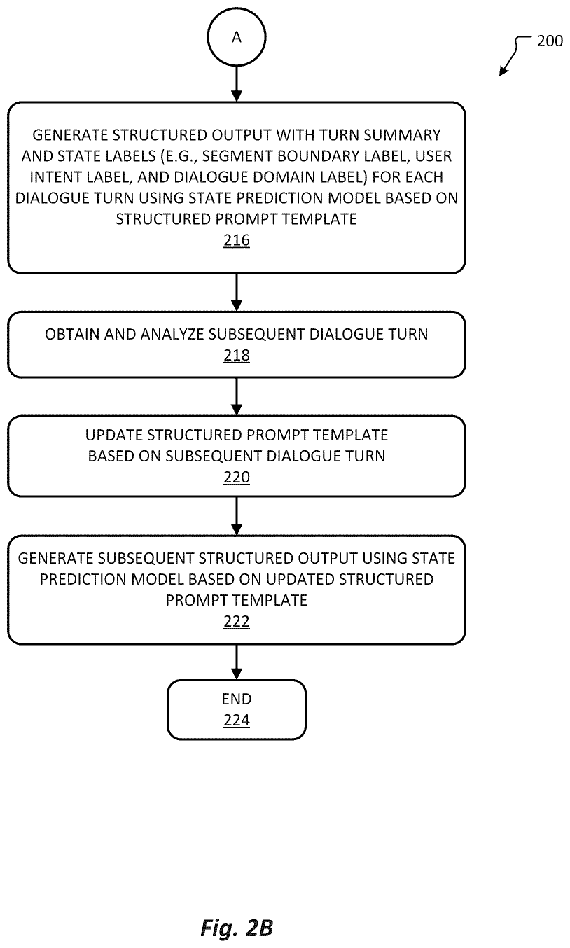

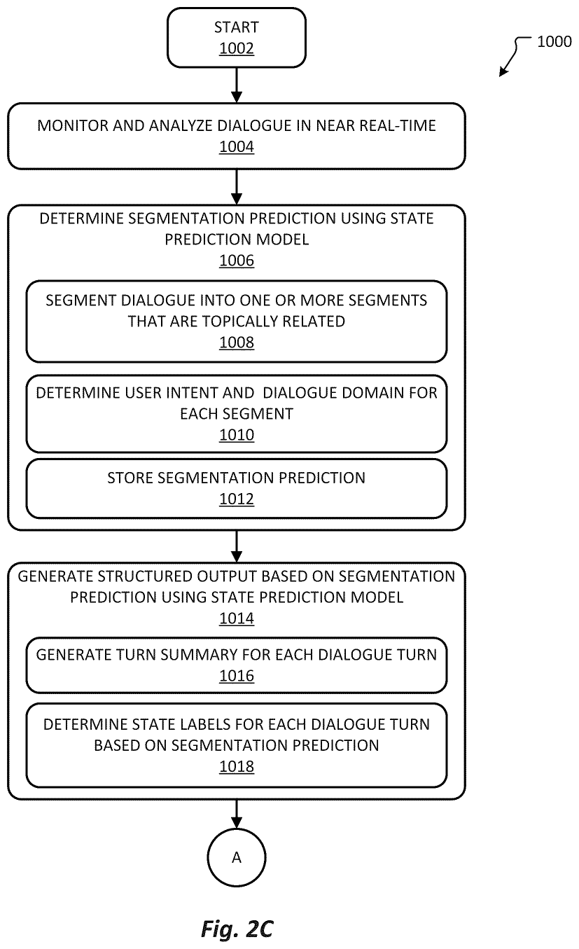

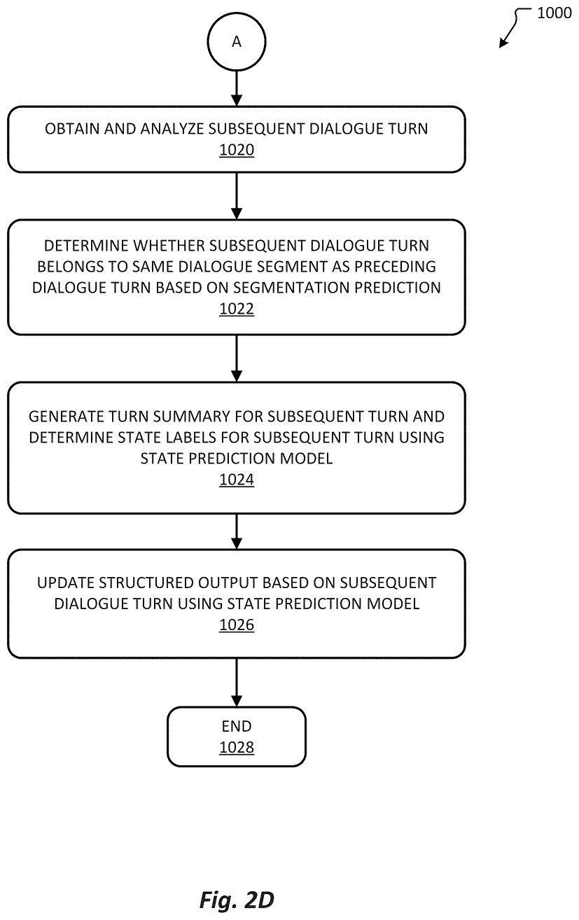

Referring now to FIGS. 2A and 2B, a method 200 for tracking dialogue states in an open-domain dialogue is provided. A general order for the steps of the method 200 is shown in FIGS. 2A and 2B. Generally, the method 200 starts at 202 and ends at 224. The method 200 may include more or fewer steps or may arrange the order of the steps differently than those shown in FIGS. 2A and 2B. In the illustrative aspect, the method 200 is performed by a computing device (e.g., a server 140). However, it should be appreciated that one or more steps of the method 200 may be performed by another device (e.g., a user device 120) of a user 110.

Specifically, in some aspects, the method 200 may be performed by a dialogue tracking tool (e.g., 150) executed on the server 140. For example, the server 140 may be any suitable computing device that is capable of executing a dialogue tracking tool (e.g., 150). For example, the computing device 120 may be, but is not limited to, a computer, a notebook, a laptop, a mobile device, a smartphone, a tablet, a portable device, a wearable device, or any other suitable computing device that is capable of communicating with the server (e.g., 160). The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 200 shall be explained with reference to the systems, components, modules, software, data structures, user interfaces, etc. described in conjunction with FIG. 1 and FIGS. 7-9.

The method 200 starts at operation 202, where flow may proceed to 204. At operation 204, the dialogue tracking tool 150 monitors and analyzes a dialogue in near real-time. The dialogue is a conversation between two or more parties. The party may be a human or an artificial intelligence (AI) agent. For example, the dialogue may be open-domain, open-ended, LLM-driven conversations. As described above, a real open-domain dialogue often contains of extensive back-and-forth between parties (e.g., clarification, negotiation, etc.) in order to pursue a single intent or topic, and contexts may shift multiple times within a single dialogue among unrelated intents and/or topics. For example, a single intent may span several turns in open-domain conversation, and a single conversation may contain multiple intents. As described above, near real-time means that the dialogue tracking tool 150 obtains or receives utterances of the dialogue occurring in real-time as quickly as the network 130 will allow.

At operation 206, the dialogue tracking tool 150 generates a structured prompt template for a state prediction model based on the dialogue. It should be appreciated that the state prediction model is one or more large language models (LLMs) (e.g., GPT4, KOSMOS). The structured prompt template includes labeling instructions, a structured valid state list, and a turn-by-turn structured representation of the dialogue.

To do so, at operation 208, the dialogue tracking tool 150 generates the labeling instructions, which includes segmentation instructions and pre-analytical recollection (PAR) instructions. As described above, the segmentation instructions instruct the state prediction model to segment the dialogue into one or more segments that are contextually related. In other words, each dialogue segment is contiguous subsequences of utterances that are topically related (e.g., related to a single intent or topic). The segmentation instructions instruct the state prediction model to identify a segment boundary when no topical relation between a dialogue turn and its preceding context could be identified. Additionally, the segmentation instructions further instruct the state prediction model to use the same user intent and dialogue domain for dialogue turns within the same dialogue segment. Without the segmentation instructions, the state prediction model may over-index on content of a dialogue turn without considering the fuller preceding context, which may lead to conflicting intent and domain label prediction between dialogue turns within a coherent single topic segment of the dialogue.

The PAR instructions further provide continuity of state alignment. The PAR instructions instruct the state prediction model to summarize each dialogue turn before determining state labels of the corresponding dialogue turn. Additionally, the PAR instructions further instruct the state prediction model to refer back to the prior contextual segments when determining state labels. In other words, grounding each output state prediction on the content of the corresponding dialogue turn and/or the prior contextual segments allows the state prediction model to accurately track long dialogue context without forgetting or hallucination.

At operation 210, the dialogue tracking tool 150 generates a structured valid state list based on valid state values associated with the dialogue. For example, the valid state values include one or more valid segment boundary labels, one or more valid intent labels, and one or more valid domain labels related to the dialogue. To do so, the valid state values are formatted into a structured representation (e.g., a hierarchical Extensible Markup Language (XML)-structured format).

Additionally, at operation 212, the dialogue tracking tool 150 generates a turn-by-turn structured dialogue by converting the dialogue into a structured representation of dialogue at a turn level. In other words, the turn-by-turn structured representation of the dialogue includes a structured representation of each dialogue turn of the dialogue. For example, as illustrated in FIG. 4, an exemplary dialogue between a user and an AI agent is converted into a structured representation in a hierarchical XML-structured format, where dialogue turns are marked with turn id number <T{id}> . . . </T{id}> numbered from 1 to N and each dialogue turn includes nested user and agent turns marked with appropriate tags (e.g., <user> . . . </user> and <agent> . . . </agent>). It should be appreciated that the dialogue may be between multiple users or between one or more users and one or more AI agents.

Subsequently, at operation 214, the dialogue tracking tool 150 generates the structured prompt template for the state prediction model based on labeling instructions, the structured valid state list, and the turn-by-turn structured dialogue. It should be appreciated that the structured prompt template does not include any example input-output pairs (e.g., zero-shot). For example, as illustrated in FIG. 4, the structured prompt template may be generated by appending the turn-by-turn structured dialogue to the structured valid state list and the labeling instructions. In an example shown in FIG. 4, the structured prompt template is in a hierarchical XML-structured format, which is human-readable and flexible while still being highly structured. The structured prompt template is inputted to the state prediction model (e.g., GPT4), which provide a structured output representation. The structured input and output representation helps provide coherence and consistency to the inputs and outputs, allowing the state prediction model to accurately determine and tag the conversation state.

At operation 216 in FIG. 2B, the dialogue tracking tool 150 generates a structured output using the state prediction model based on the structured prompt template. The structured output is generated in the same structured format (e.g., a hierarchical XML-structured format) as the structured prompt template and includes a turn summary and state labels (e.g., segment boundary, user intent, and dialogue domain labels) for each dialogue turn. For example, the segmentary boundary label is a binary label, and the intent and domain labels are categorical labels.

For example, as illustrated in FIG. 4, the structured output is generated in a hierarchical XML-structured format in which each dialogue turn form 1 to N comprises an XML tree <T{id}> . . . </T{id}> and nested XML tags within it. The labels of the nested tags (e.g., <preceding_topical_relation> . . . </preceding_topical_relation>, <intent> . . . </intent>, and <domain> . . . </domain>) represent the segment boundaries and slots of interest, and each value between opening and closing tags represent the one or more predicted value.

It should be appreciated that the structured outputs generated in a bounded well-defined structured format are more likely to be aligned with labeling instructions than free-form texts and are easier to parse, which reduces postprocessing requirements.

Subsequently, at operation 218, the dialogue tracking tool 150 obtains and analyzes a subsequent dialogue turn in the same dialogue in near real-time.

At operation 220, the dialogue tracking tool 150 updates the structured prompt template based on the subsequent dialogue turn. For example, the turn-by-turn structured dialogue is generated or updated to include the subsequent dialogue turn.

At operation 222, the dialogue tracking tool 150 generates a subsequent structured output using the state prediction model based on the updated structured prompt template. In some embodiments, the previous structured output may also be considered when generating the subsequent structured output using the state prediction model. Subsequently, the method 200 may end at operation 224.

Referring now to FIGS. 2C and 2D, a method 1000 for segmenting an open-domain dialogue and determining dialogue states based on the dialogue segmentation is provided. A general order for the steps of the method 1000 is shown in FIG. 2C. Generally, the method 1000 starts at 1002 and ends at 1028. The method 200 may include more or fewer steps or may arrange the order of the steps differently than those shown in FIG. 2C. In the illustrative aspect, the method 1000 is performed by a computing device (e.g., a server 140). However, it should be appreciated that one or more steps of the method 1000 may be performed by another device (e.g., a user device 120) of a user 110.

Specifically, in some aspects, the method 1000 may be performed by a dialogue tracking tool (e.g., 150) executed on the server 140. For example, the server 140 may be any suitable computing device that is capable of executing a dialogue tracking tool (e.g., 150). The method 1000 can be executed as a set of computer-executable instructions executed by a computer system and encoded or stored on a computer readable medium. Further, the method 1000 can be performed by gates or circuits associated with a processor, Application Specific Integrated Circuit (ASIC), a field programmable gate array (FPGA), a system on chip (SOC), or other hardware device. Hereinafter, the method 1000 shall be explained with reference to the systems, components, modules, software, data structures, user interfaces, etc. described in conjunction with FIG. 1 and FIGS. 7-9.

The method 1000 starts at operation 1002, where flow may proceed to 1004. At operation 1004, the dialogue tracking tool 150 monitors and analyzes a dialogue in near real-time. The dialogue is a conversation between two or more parties. The party may be a human or an artificial intelligence (AI) agent. For example, the dialogue may be open-domain, open-ended, LLM-driven conversations. As described above, a real open-domain dialogue often contains of extensive back-and-forth between parties (e.g., clarification, negotiation, etc.) in order to pursue a single intent or topic, and contexts may shift multiple times within a single dialogue among unrelated intents and/or topics. For example, a single intent may span several turns in open-domain conversation, and a single conversation may contain multiple intents. As described above, near real-time means that the dialogue tracking tool 150 obtains or receives utterances of the dialogue occurring in real-time as quickly as the network 130 will allow.

At operation 1006, the dialogue tracking tool 150 determines a segmentation prediction using a state prediction model. The segmentation prediction includes segmentation boundaries indicating each dialogue segment and user intents and dialogue domains for dialogue segments. To do so, at operation 1008, the dialogue tracking tool 150 segments the dialogue into one or more segments that are topically related. As described above, the dialogue tracking tool 150 instructs the state prediction model to segment the dialogue into one or more segments that are contextually related. In other words, each dialogue segment is contiguous subsequences of utterances that are topically related (e.g., related to a single intent or topic). For example, the dialogue tracking tool 150 instructs the state prediction model to identify a segment boundary when no topical relation between a dialogue turn and its preceding context could be identified.

Additionally, at operation 1010, a user intent and a dialogue domain for each dialogue segment are determined using the state prediction model. As described further below, the state prediction model is configured to apply the same user intent and dialogue domain for one or more dialogue turns within each dialogue segment. Without the dialogue segmentation, the state prediction model may over-index on content of a dialogue turn without considering the fuller preceding context, which may lead to conflicting intent and domain label prediction between dialogue turns within a coherent single topic segment of the dialogue. At operation 1012, the dialogue tracking tool 150 stores the segmentation prediction.

Subsequently, at operation 1014, the dialogue tracking tool 150 generates a structured output based on the segmentation prediction using the state prediction model. To do so, at operation 1016, the dialogue tracking tool 150 generates a turn summary for each dialogue turn of the dialogue. Additionally, at operation 1018, the dialogue tracking tool 150 determines state labels for each dialogue turn based on the segmentation prediction. For example, the state labels for each dialogue turn includes segment boundary, user intent, and dialogue domain labels. To do so, the state prediction model is instructed to determine whether a corresponding dialogue turn belongs to the to the same dialogue segment as a preceding dialogue turn based on the segmentation prediction. In other words, the state prediction model is instructed to determine whether a present dialogue turn is topically related to a context of a preceding dialogue turn based on the segmentation prediction. If the present dialogue turn is topically related to the context of the preceding dialogue turn, the same user intent and dialogue domain as the preceding dialogue turn are applied to the present dialogue turn (i.e., the same user intent and same dialogue domain are applied to all dialogue turns within the same dialogue segment). If the present dialogue turn is not topically related to the context of the preceding dialogue turn, a user intent and dialogue domain for the present dialogue turn is predicted based the context of one or more proceeding segments of the dialogue.

Subsequently, at operation 1020, the dialogue tracking tool 150 further obtains and analyzes a subsequent dialogue turn in the same dialogue in near real-time. At operation 1022, the dialogue tracking tool 150 determines whether the subsequent dialogue turn belongs to the same dialogue segment as a preceding dialogue turn based on the segmentation prediction. At operation 1024, the dialogue tracking tool 150 instructs the state prediction model to generate a turn summary for the subsequent turn and determine state labels for the subsequent turn based on the determination at operation 1022. For example, in response to determining that the subsequent dialogue turn belongs to the same dialogue segment as the preceding dialogue, the same state labels as the preceding dialogue turn are applied to the subsequent dialogue turn. However, in response to determining that the subsequent dialogue turn does not belong to the same dialogue segment as the preceding dialogue, the state labels for the subsequent dialogue turn are determined based on context of one or more proceeding segments of the dialogue and the structured output of one or more proceeding dialogue turns. Subsequently, at operation 1026, the dialogue tracking tool 150 updates the structured output based on the subsequent dialogue turn. Subsequently, the method 200 may end at operation 1028.

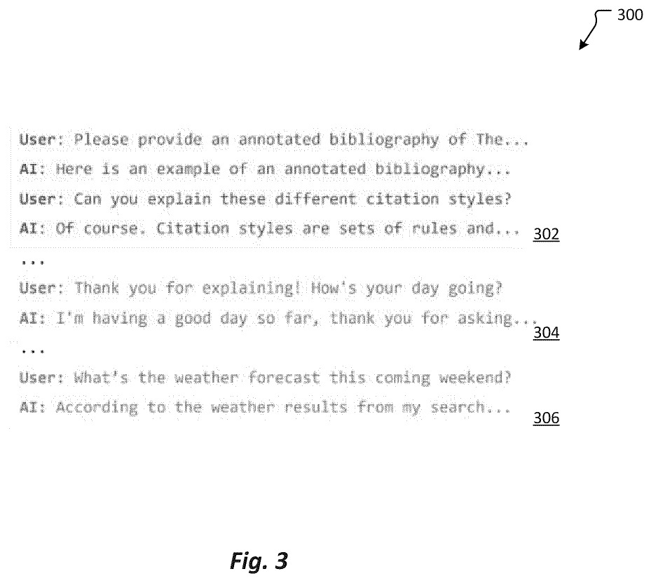

Referring now to FIG. 3, an exemplary dialogue 300 is synthesized to illustrate that a single user intent may span several dialogue turns in an open-domain dialogue and a single dialogue may contain multiple user intents. The exemplary dialogue 300 is an open-domain, open-ended, LLM-driven dialogue between a user and an artificial intelligent (AI) agent that extends over multiple dialogue turns to discuss diverse topics. For example, a user intent for a first set of dialogue turns 302 is creating an annotated bibliography, a user intent for a second set of dialogue turns 304 is social chitchat, and a user intent for a third set of dialogue turns 306 is checking the weather.

FIG. 4 illustrate an overview 400 of tracking dialogue states in an open-domain dialogue between a user and an AI agent is provided. As described above the structured prompt template includes a structured valid state list, labeling instructions, and a turn-by-turn structured representation of the dialogue. As illustrated in FIG. 4, the structured prompt template is generated in a hierarchical XML-structured format. The structured valid state list is generated based on valid state values associated with the dialogue. For example, the valid state values include one or more valid segment boundary labels, one or more valid intent labels, and one or more valid domain labels. To do so, the valid state values are formatted into the XML-structured format. Additionally, the raw dialogue is converted into a structured representation in the XML-structured format, where dialogue turns are marked with turn id number <T{id}> . . . </T{id}> numbered from 1 to N and each dialogue turn includes nested user and agent turns marked with appropriate tags (e.g., <user> . . . </user> and <agent> . . . </agent>).

Additionally, the structured output is generated in a hierarchical XML-structured format in which each dialogue turn form 1 to N comprises an XML tree <T{id}> . . . </T{id}> and nested XML tags within it. The labels of the nested tags (e.g., <preceding_topical_relation> . . . </preceding_topical_relation>, <intent> . . . </intent>, and <domain> . . . </domain>) represent the segment boundaries and slots of interest, and each value between opening and closing tags represent the one or more predicted value.

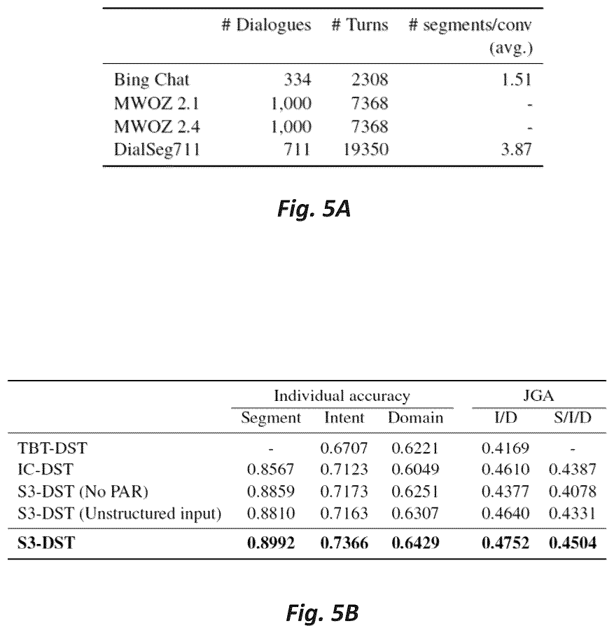

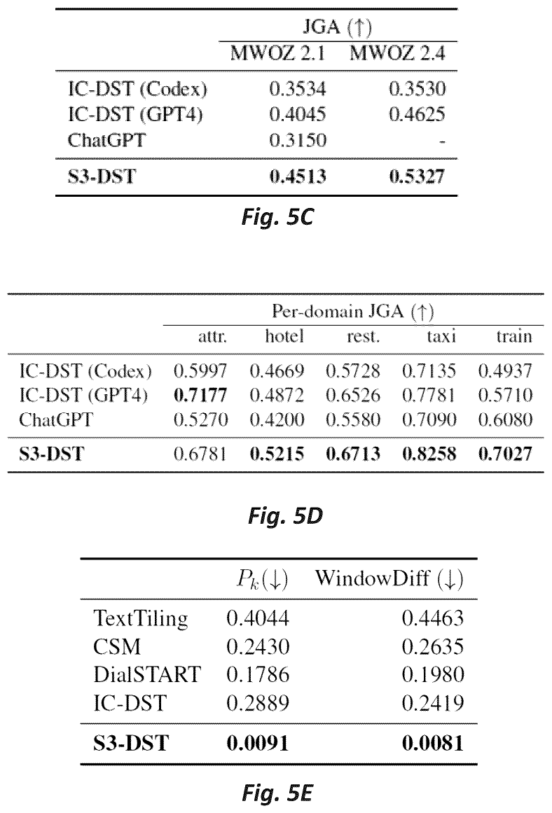

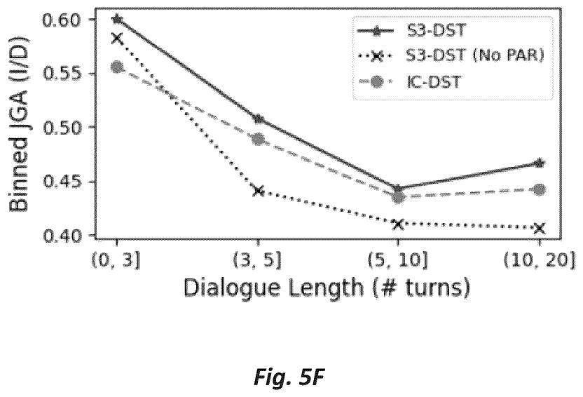

FIGS. 5A-E are experimental results illustrating that a structured prompting approach for open-domain dialogue state tracking (DST), also referred to as “S3-DST” in FIGS. 5A-E, yields large gains over comparable zero-shot prompts. As discussed above, a dialogue tracking tool (e.g., 150) uses a structured prompting approach for open-domain DST (S3-DST) in a zero-shot setting for dialogue tagging.

Human-LLM Dialog Dataset Construction: To evaluate the S3-DST approach on human-LLM conversations spanning a large variety of topics and intents, logs from Microsoft's Bing Chat system, which is an LLM chat interface backed by the Bing search engine, were collected. Specifically, 6K anonymized English conversations were randomly sampled from Bing Chat. Since the S3-DST operates under a zero-shot assumption, a training set was not collected. Instead, only a development set for prompt iteration and a test set for evaluation were collected. Two complementary sampling approaches for the development and test sets were used. First, 75 conversations were randomly sampled for each set from the initial pool of 6K English conversations. Next, that pool was filtered to conversations with 5 or more turns to represent “challenging” conversations that are more likely to contain intent and domain shifts. 75 conversations for each set from this filtered challenge set were sampled. After removing any overlaps between the development and test sets, 150 development conversations and 145 test conversations, corresponding to 882 development turns and 923 test turns, remained. Evaluation test set statistics are shown in FIG. 5A.

Annotation: To obtain ground-truth labels for evaluation, human annotations for segment and state were obtained from annotators with a high degree of technical expertise and familiarity with the Bing Chat system. For each turn, the annotators were instructed to provide binary IsSegmentBoundary labels, categorical SegmentIntent labels, and categorical SegmentDomain labels. The annotators were instructed to mark a segment boundary when no topical relation between a turn and its preceding context could be identified. For intent and domain, taxonomies developed for the Bing Chat system consisting of 4 intents and 49 domains were used. Because of the large number of domains, the annotators were provided four candidate domain values and an other option for each turn. To ensure inter-annotator agreement before labeling the full dataset, annotations on a set of 68 turns were first gathered and Fleiss' kappa per label type was computed. A Fleiss kappa of κ=0.83 for IsSegmentBoundary, κ=0.74 for SegmentIntent, and κ=0.88 for SegmentDomain, all of which are considered high agreement on the Fleiss kappa scale.

Public Benchmarks: There are no readily available public dialogue benchmarks that span the breadth of domains and intents reflected in the Bing Chat data. As such, separate DST and segmentation evaluations on public benchmarks were performed using three datasets (MWOZ 2.1, MWOZ 2.4, and DialSeg711).

The MultiWOZ (MWOZ) multi-domain dialogue dataset is currently one of the most common DST benchmarks. MWOZ is a task-oriented dataset consisting of 1K test dialogues and 7.3k test turns. As shown in FIG. 5A, two updated versions MWOZ 2.1 and 2.4 were used. The latter is considered the “cleanest” version of MWOZ, while the former has been used more frequently in the literature.

The DialSeg711 benchmark has been used frequently in recent dialogue segmentation research. It is an English dataset in which 711 multi-segment dialogues are constructed by joining dialogues from existing task-oriented dialogue corpora.

Baselines: Zero-shot baselines for TBT-DST, IC-DST, S3-DST (No PAR), S3-DST (Unstructured prompt), and S3-DST have been considered. All baselines for Bing Chat dataset use GPT4 as the LLM backbone.

The IC-DST baseline is a zero-shot version of the prompting strategy, which is heavily adapted for the open-domain dialogue setting.

The TBT-DST baseline is a version of S3-DST that does not include segmentation instructions and obtains intent and domain labels on a turn-by-turn basis using the S3-DST prompt configuration. Additionally, two ablations of S3-DST: No PAR refers to a S3-DST prompt without PAR instructions, and Unstructured prompt refers to a S3-DST prompt that formats all instructions and dialogue using plain text rather than XML.

On MWOZ, the numbers for IC-DST were reprinted using Codex-175B. IC-DST were rerun using GPT4. Additionally, zero-shot ChatGPT performance on MWOZ 2.1 was reprinted.

The unsupervised TextTiling, CSM, and DialStart methods were considered. All numbers were reprinted. IC-DST baseline prompted to elicit segmentation labels in the same SQL output format as the original IC-DST was used.

Metrics: For state tracking, Joint Goal Accuracy (JGA), which measures the proportion of turns for which all state values are correctly inferred, was considered. Intent and domain accuracy on Bing Chat may illustrate current capabilities and limitations of LLMs on open-domain conversational data. For segmentation, PK and WindowDiff were considered, which are both error metrics (i.e., lower is better) that quantify the difference between predicted and ground-truth segment boundaries using an adjustable sliding window.

As shown in FIG. 5B, S3-DST prompt achieves the highest performance across intent, domain, and JGA (joint intent and accuracy) prediction across turns.

Additionally, the TBT-DST baseline, which does not perform segmentation, has by far the lowest performance. As described above, without instructing the LLM to use the same intent and domain within a dialogue segment, the LLM tends to over-index on the content of the turn without considering the fuller preceding context, which may lead to conflicting intent and domain labels between turns within a coherent single-topic dialogue.

IC-DST is a very strong baseline. However, while IC-DST makes use of structured outputs, it does not have a corresponding structured input representation, which may lead to higher hallucination of nonexistent turns compared to S3-DST.

As such, the two ablations of S3-DST both underperform compared to S3-DST, confirming the importance of PAR and structured inputs that the LLM can refer back to during generation. FIG. 5F plots the relationship between dialogue length and performance shows that S3-DST avoids the steep degradation in performance of the no-PAR ablation as the dialogues get longer. Such results support the necessity of PAR for long dialogues of 10 turns or more.

FIGS. 5C and 5D provide MWOZ numbers in total and per-domain. S3-DST achieves state-of-the-art zero-shot JGA compared to strong LLMs by a large margin. Even the strongest zero-shot baseline, IC-DST (GPT4), has an absolute performance gap of nearly 5 points JGA on MWOZ 2.1 and 7 points on MWOZ 2.4. In nearly all individual domains, S3-DST outperforms IC-DST (GPT4), and some by a large margin, for example over 13 points JGA improvement on the train domain.

FIG. 5E shows performance on DialSeg711. S3-DST achieves nearly zero error on this dataset. Specifically, DialSeg711 is constructed by joining dialogues about very different topics, which leads to very artificial and abrupt context shifts between segments. However, IC-DST prompting baseline leads to much higher error than S3-DST. When the LLM fails to track the dialogue context for several conversations in the dataset, it leads to forgetting of the original conversation context. These results highlight the importance of PAR and dialogue context tracking for successful segmentation.

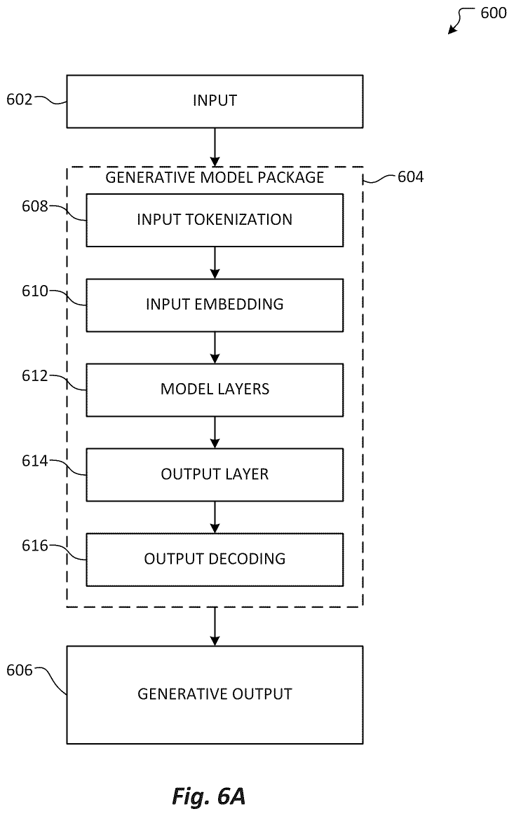

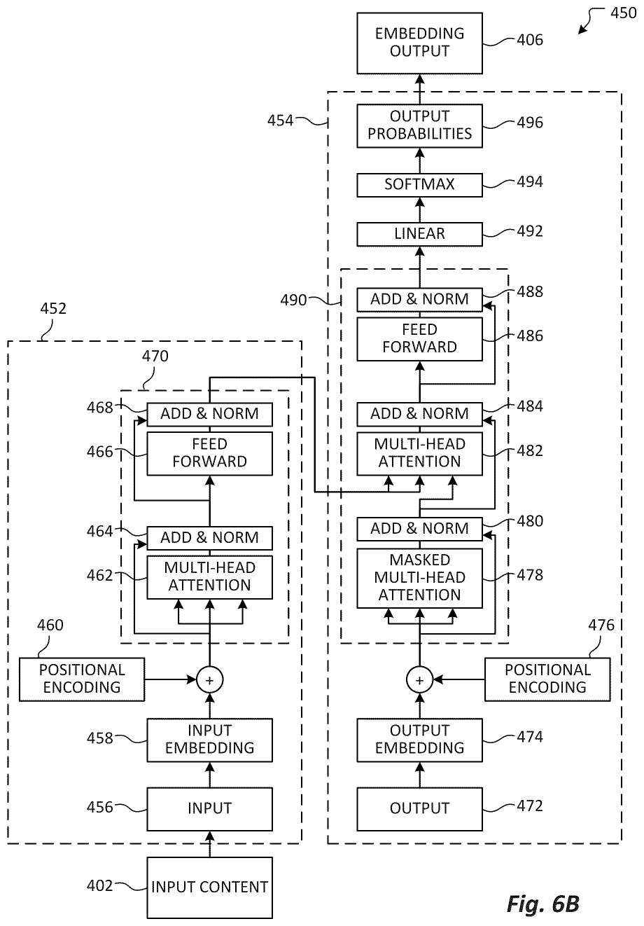

FIGS. 6A and 6B illustrate overviews of an example generative machine learning model that may be used according to aspects described herein. With reference first to FIG. 6A, conceptual diagram 600 depicts an overview of pre-trained generative model package 604 that processes an input 602 to generate model output for storing entries in and/or retrieving information from a generative model output 606 (e.g., a structured output) according to aspects described herein.

In examples, generative model package 604 is pre-trained according to a variety of inputs (e.g., a variety of human languages, a variety of programming languages, and/or a variety of content types) and therefore need not be finetuned or trained for a specific scenario. Rather, generative model package 604 may be more generally pre-trained, such that input 602 includes a prompt that is generated, selected, or otherwise engineered to induce generative model package 604 to produce certain generative model output 606. It will be appreciated that input 602 and generative model output 606 may each include any of a variety of content types, including, but not limited to, text output, image output, audio output, video output, programmatic output, and/or binary output, among other examples. In examples, input 602 and generative model output 606 may have different content types, as may be the case when generative model package 604 includes a generative multimodal machine learning model.

As such, generative model package 604 may be used in any of a variety of scenarios and, further, a different generative model package may be used in place of generative model package 604 without substantially modifying other associated aspects (e.g., similar to those described herein with respect to FIGS. 1-3). Accordingly, generative model package 604 operates as a tool with which machine learning processing is performed, in which certain inputs 602 to generative model package 604 are programmatically generated or otherwise determined, thereby causing generative model package 604 to produce model output 606 that may subsequently be used for further processing.

Generative model package 604 may be provided or otherwise used according to any of a variety of paradigms. For example, generative model package 604 may be used local to a computing device (e.g., the computing device 120 in FIG. 1) or may be accessed remotely from a machine learning service (e.g., the server 140 in FIG. 1). In other examples, aspects of generative model package 604 are distributed across multiple computing devices. In some instances, generative model package 604 is accessible via an application programming interface (API), as may be provided by an operating system of the computing device and/or by the machine learning service, among other examples.

With reference now to the illustrated aspects of generative model package 604, generative model package 604 includes input tokenization 608, input embedding 610, model layers 612, output layer 614, and output decoding 616. In examples, input tokenization 608 processes input 602 to generate input embedding 610, which includes a sequence of symbol representations that corresponds to input 602. Accordingly, input embedding 610 is processed by model layers 612, output layer 614, and output decoding 616 to produce model output 606. An example architecture corresponding to generative model package 604 is depicted in FIG. 6B, which is discussed below in further detail. Even so, it will be appreciated that the architectures that are illustrated and described herein are not to be taken in a limiting sense and, in other examples, any of a variety of other architectures may be used.

FIG. 6B is a conceptual diagram that depicts an example architecture 650 of a pre-trained generative machine learning model that may be used according to aspects described herein. As noted above, any of a variety of alternative architectures and corresponding ML models may be used in other examples without departing from the aspects described herein.

As illustrated, architecture 650 processes input 602 to produce generative model output 606, aspects of which were discussed above with respect to FIG. 6A. Architecture 650 is depicted as a transformer model that includes encoder 652 and decoder 654. Encoder 652 processes input embedding 658 (aspects of which may be similar to input embedding 610 in FIG. 6A), which includes a sequence of symbol representations that corresponds to input 656. In examples, input 656 includes content data 602 corresponding to a content item.

Further, positional encoding 660 may introduce information about the relative and/or absolute position for tokens of input embedding 658. Similarly, output embedding 674 includes a sequence of symbol representations that correspond to output 672, while positional encoding 676 may similarly introduce information about the relative and/or absolute position for tokens of output embedding 674.

As illustrated, encoder 652 includes example layer 670. It will be appreciated that any number of such layers may be used, and that the depicted architecture is simplified for illustrative purposes. Example layer 670 includes two sub-layers: multi-head attention layer 662 and feed forward layer 666. In examples, a residual connection is included around each layer 662, 666, after which normalization layers 664 and 668, respectively, are included.

Decoder 654 includes example layer 690. Similar to encoder 652, any number of such layers may be used in other examples, and the depicted architecture of decoder 654 is simplified for illustrative purposes. As illustrated, example layer 690 includes three sub-layers: masked multi-head attention layer 678, multi-head attention layer 682, and feed forward layer 686. Aspects of multi-head attention layer 682 and feed forward layer 686 may be similar to those discussed above with respect to multi-head attention layer 662 and feed forward layer 666, respectively. Additionally, masked multi-head attention layer 678 performs multi-head attention over the output of encoder 652 (e.g., output 672). In examples, masked multi-head attention layer 678 prevents positions from attending to subsequent positions. Such masking, combined with offsetting the embeddings (e.g., by one position, as illustrated by multi-head attention layer 682), may ensure that a prediction for a given position depends on known output for one or more positions that are less than the given position. As illustrated, residual connections are also included around layers 678, 682, and 686, after which normalization layers 680, 684, and 688, respectively, are included.

Multi-head attention layers 662, 678, and 682 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 6B (e.g., by a corresponding normalization layer 664, 680, or 684).

Feed forward layers 666 and 686 may each be a fully connected feed-forward network, which applies to each position. In examples, feed forward layers 666 and 686 each include a plurality of linear transformations with a rectified linear unit activation in between. In examples, each linear transformation is the same across different positions, while different parameters may be used as compared to other linear transformations of the feed-forward network.

Additionally, aspects of linear transformation 692 may be similar to the linear transformations discussed above with respect to multi-head attention layers 662, 678, and 682, as well as feed forward layers 666 and 686. Softmax 694 may further convert the output of linear transformation 692 to predicted next-token probabilities, as indicated by output probabilities 696. It will be appreciated that the illustrated architecture is provided in as an example and, in other examples, any of a variety of other model architectures may be used in accordance with the disclosed aspects.

Accordingly, output probabilities 696 may thus form generative model output 606 according to aspects described herein, such that the output of the generative ML model (e.g., which may include one or more state labels) is used as input for determining an action according to aspects described herein. In other examples, generative model output 606 is provided as generated structured output.

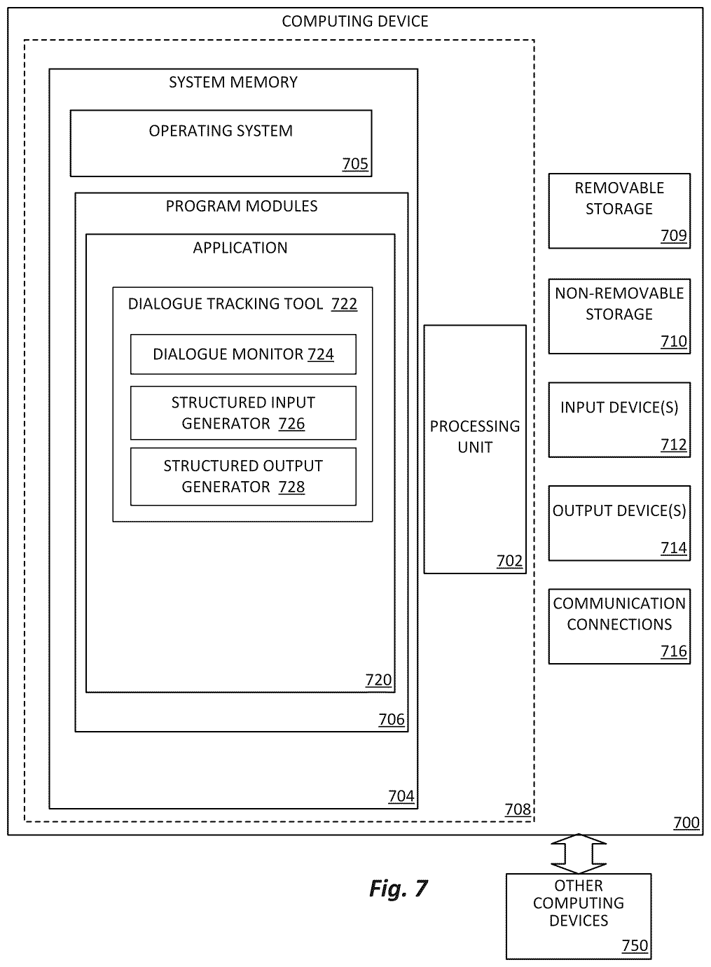

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above, including one or more devices associated with machine learning service (e.g., productive platform server 140), as well as computing device 140 discussed above with respect to FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store a dialogue tracking tool 722, including a dialogue monitor 724, a structured input generator 726, and a structured output generator 728. The operating system 705, for example, may be suitable for controlling the operation of the computing device 700.

Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

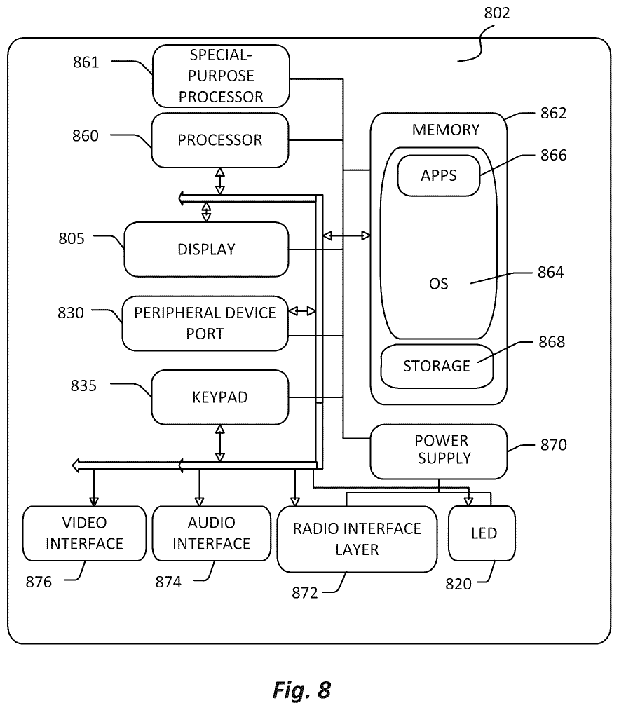

FIG. 8 illustrates a system 800 that may, for example, be a mobile computing device, such as a mobile telephone, a smart phone, wearable computer (such as a smart watch), a tablet computer, a laptop computer, and the like, with which aspects of the disclosure may be practiced. In one example, the system 800 is implemented as a “smart phone” capable of running one or more applications (e.g., browser, e-mail, calendaring, contact managers, messaging clients, games, and media clients/players). In some aspects, the system 800 is integrated as a computing device, such as an integrated personal digital assistant (PDA) and wireless phone.

In a basic configuration, such a mobile computing device is a handheld computer having both input elements and output elements. The system 800 typically includes a display 805 and one or more input buttons that allow the user to enter information into the system 800. The display 805 may also function as an input device (e.g., a touch screen display).

If included, an optional side input element allows further user input. For example, the side input element may be a rotary switch, a button, or any other type of manual input element. In alternative aspects, system 800 may incorporate more or less input elements. For example, the display 805 may not be a touch screen in some aspects. In another example, an optional keypad 835 may also be included, which may be a physical keypad or a “soft” keypad generated on the touch screen display.

In various aspects, the output elements include the display 805 for showing a graphical user interface (GUI), a visual indicator (e.g., a light emitting diode 820), and/or an audio transducer 825 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 800 also includes a non-volatile storage area 868 within the memory 862. The non-volatile storage area 868 may be used to store persistent information that should not be lost if the system 800 is powered down. The application programs 866 may use and store information in the non-volatile storage area 868, such as e-mail or other messages used by an e-mail application, and the like. A synchronization application (not shown) also resides on the system 800 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the system 800 described herein (e.g., a content capture manager, a content retrieval manager, etc.).

The system 800 has a power supply 870, which may be implemented as one or more batteries. The power supply 870 might further include an external power source, such as an AC adapter or a powered docking cradle that supplements or recharges the batteries.

The system 800 may also include a radio interface layer 872 that performs the function of transmitting and receiving radio frequency communications. The radio interface layer 872 facilitates wireless connectivity between the system 800 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 800 may further include a video interface 876 that enables an operation of an on-board camera 830 to record still images, video stream, and the like.

It will be appreciated that system 800 may have additional features or functionality. For example, system 800 may also include additional data storage devices (removable and/or non-removable) such as, magnetic disks, optical disks, or tape. Such additional storage is illustrated in FIG. 8 by the non-volatile storage area 868.

Data/information generated or captured and stored via the system 800 may be stored locally, as described above, or the data may be stored on any number of storage media that may be accessed by the device via the radio interface layer 872 or via a wired connection between the system 800 and a separate computing device associated with the system 800, for example, a server computer in a distributed computing network, such as the Internet. As should be appreciated, such data/information may be accessed via the radio interface layer 872 or via a distributed computing network. Similarly, such data/information may be readily transferred between computing devices for storage and use according to any of a variety of data/information transfer and storage means, including electronic mail and collaborative data/information sharing systems.

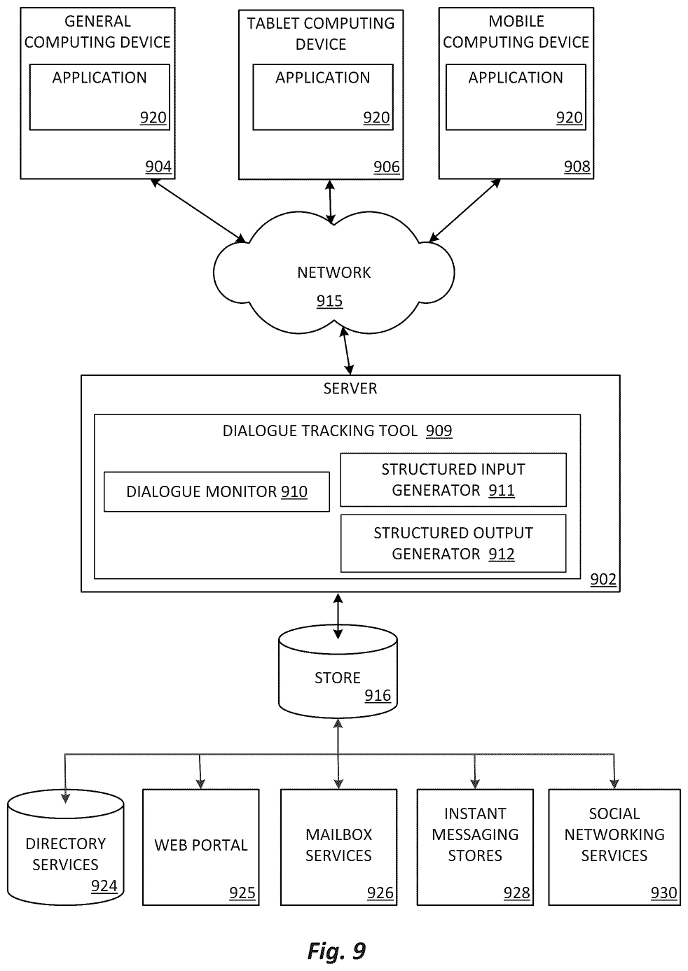

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 924, a web portal 925, a mailbox service 926, an instant messaging store 928, or a social networking site 930.

An application 920 (e.g., similar to the application 520) may be employed by a client that communicates with server device 902. Additionally, or alternatively, a dialogue tracking tool 909, which includes a dialogue monitor 910, a structured input generator 911, and a structured output generator 912, may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these examples of the computing devices may obtain content from the store 916, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for open-domain dialogue segmentation and state tracking is provided. The method includes obtaining and analyzing a dialogue in near real-time, the dialogue being an open-domain dialogue, generating a structured prompt template for a state prediction model based on the dialogue, and generating a structured output using the state prediction model based on the structured prompt template, the structured output including a turn summary and state labels for each dialogue turn.

In accordance with at least one aspect of the above method, the method may further include where the state labels for each dialogue turn include a segment boundary label, a user intent label, and a dialogue domain label for each dialogue turn.

In accordance with at least one aspect of the above method, the method may further include where the structured prompt template includes labeling instructions, a structured valid state list, and a turn-by-turn structured dialogue in a structured representation format.

In accordance with at least one aspect of the above method, the method may further include where generating the structured prompt template for the state prediction model based on the dialogue comprises generating the labeling instructions, wherein the labeling instructions include segmentation instructions and pre-analytical recollection (PAR) instructions.

In accordance with at least one aspect of the above method, the method may further include where the segmentation instructions are designed to instruct the state prediction model to segment the dialogue into one or more segments that are topically related, wherein each dialogue segment of the one or more segments is contiguous subsequences of utterances that are topically related.

In accordance with at least one aspect of the above method, the method may further include where the segmentation instructions are designed to instruct the state prediction model to identify a segment boundary when no topical relation between a dialogue turn and its preceding context could be identified.

In accordance with at least one aspect of the above method, the method may further include where the segmentation instructions are designed to instruct the state prediction model to use same user intent and dialogue domain for dialogue turns within the same dialogue segment.

In accordance with at least one aspect of the above method, the method may further include where the PAR instructions are designed to instruct the state prediction model to summarize each dialogue turn before determining state labels of the corresponding dialogue turn.

In accordance with at least one aspect of the above method, the method may further include where the PAR instructions are designed to instruct the state prediction model to refer back to the prior contextual segments when determining state labels of the corresponding dialogue turn.

In accordance with at least one aspect of the above method, the method may further include where generating the structured prompt template for the state prediction model based on the dialogue comprises generating the structured valid state list by formatting one or more valid state values associated with the dialogue into a structured representation.

In accordance with at least one aspect of the above method, the method may further include where generating the structured prompt template for the state prediction model based on the dialogue comprises generating the turn-by-turn structured dialogue by converting the dialogue into a structured representation at a turn level.

In accordance with at least one aspect of the above method, the method may further include where the structured representation is in a hierarchical Extensible Markup Language (XML)-structured format.

In accordance with at least one aspect of the above method, the method may further include where the state prediction model is a generative large language model (LLM) or a multimodal large language model (MLLM).

In accordance with at least one example of the present disclosure, a computing device for open-domain dialogue segmentation and state tracking is provided. The computing device may include a processor and a memory having a plurality of instructions stored thereon that, when executed by the processor, causes the computing device to obtain and analyze a dialogue in near real-time, the dialogue being an open-domain dialogue, generate a structured prompt template for a state prediction model based on the dialogue, and generate a structured output using the state prediction model based on the structured prompt template. The structured output includes a turn summary and state labels for each dialogue turn, and the state labels for each dialogue turn includes a segment boundary label, a user intent label, and a dialogue domain label for each dialogue turn.

In accordance with at least one aspect of the above computing device, the computing device may comprise where the structured prompt template includes labeling instructions, a structured valid state list, and a turn-by-turn structured dialogue in a structured representation format.

In accordance with at least one aspect of the above computing device, the computing device may comprise where to generate the structured prompt template for the state prediction model based on the dialogue comprises to generate the labeling instructions, wherein the labeling instructions include segmentation instructions and pre-analytical recollection (PAR) instructions.

In accordance with at least one aspect of the above computing device, the computing device may comprise where the segmentation instructions are designed to instruct the state prediction model to (1) segment the dialogue into one or more segments that are topically related, wherein each dialogue segment of the one or more segments is contiguous subsequences of utterances that are topically related, (2) identify a segment boundary when no topical relation between a dialogue turn and its preceding context could be identified, and (3) use same user intent and dialogue domain for dialogue turns within the same dialogue segment.

In accordance with at least one aspect of the above computing device, the computing device may comprise where the PAR instructions are designed to instruct the state prediction model to (1) summarize each dialogue turn before determining state labels of the corresponding dialogue turn, and (2) refer back to the prior contextual segments when determining state labels of the corresponding dialogue turn.

In accordance with at least one example of the present disclosure, a non-transitory computer-readable medium storing instructions for open-domain dialogue segmentation and state tracking is provided. The instructions when executed by one or more processors of a computing device, cause the computing device to obtain and analyze a dialogue in near real-time, the dialogue being an open-domain dialogue, generate a structured prompt template for a state prediction model based on the dialogue, and generate a structured output using the state prediction model based on the structured prompt template. The structured output includes a turn summary and state labels for each dialogue turn. The state labels for each dialogue turn includes a segment boundary label, a user intent label, and a dialogue domain label for each dialogue turn. The structured prompt template includes labeling instructions, a structured valid state list, and a turn-by-turn structured dialogue in a structured representation format.

In accordance with at least one aspect of the above non-transitory computer-readable medium, the instructions when executed by one or more processors further cause the computing device to perform the method where to generate the structured prompt template for the state prediction model based on the dialogue comprises to generate the labeling instructions, wherein the labeling instructions include segmentation instructions and pre-analytical recollection (PAR) instructions.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for open-domain dialogue segmentation and state tracking, the method comprising:
obtaining and analyzing a dialogue in near real-time, the dialogue being an open-domain dialogue;
generating a structured prompt template for a state prediction model based on the dialogue; and
generating a structured output using the state prediction model based on the structured prompt template, the structured output including a turn summary and state labels for each dialogue turn.

2. The method of claim 1, wherein the state labels for each dialogue turn include a segment boundary label, a user intent label, and a dialogue domain label for each dialogue turn.

3. The method of claim 1, wherein the structured prompt template includes labeling instructions, a structured valid state list, and a turn-by-turn structured dialogue in a structured representation format.

4. The method of claim 3, wherein generating the structured prompt template for the state prediction model based on the dialogue comprises:
generating the labeling instructions, wherein the labeling instructions include segmentation instructions and pre-analytical recollection (PAR) instructions.

5. The method of claim 4, wherein the segmentation instructions are designed to instruct the state prediction model to segment the dialogue into one or more segments that are topically related, wherein each dialogue segment of the one or more segments is contiguous subsequences of utterances that are topically related.

6. The method of claim 4, wherein the segmentation instructions are designed to instruct the state prediction model to identify a segment boundary when no topical relation between a dialogue turn and its preceding context could be identified.

7. The method of claim 4, wherein the segmentation instructions are designed to instruct the state prediction model to use same user intent and dialogue domain for dialogue turns within the same dialogue segment.

8. The method of claim 4, wherein the PAR instructions are designed to instruct the state prediction model to summarize each dialogue turn before determining state labels of the corresponding dialogue turn.

9. The method of claim 4, wherein the PAR instructions are designed to instruct the state prediction model to refer back to the prior contextual segments when determining state labels of the corresponding dialogue turn.

10. The method of claim 3, wherein generating the structured prompt template for the state prediction model based on the dialogue comprises:
generating the structured valid state list by formatting one or more valid state values associated with the dialogue into a structured representation.

11. The method of claim 3, wherein generating the structured prompt template for the state prediction model based on the dialogue comprises:
generating the turn-by-turn structured dialogue by converting the dialogue into a structured representation at a turn level.

12. The method of claim 11, wherein the structured representation is in a hierarchical Extensible Markup Language (XML)-structured format.

13. The method of claim 1, wherein the state prediction model is a generative large language model (LLM) or a multimodal large language model (MLLM).

14. A method for open-domain dialogue segmentation and state tracking, the method comprising:
obtaining and analyzing a dialogue, the dialogue being an open-domain dialogue;
determining a segmentation prediction using a state prediction model by segmenting the dialogue into one or more segments that are topically related and determining a user intent and a dialogue domain for each segment, each segment including contiguous subsequences of one or more dialogue turns that are topically related; and
generating a structured output based on the segmentation prediction using the state prediction model, the structured output including a turn summary and state labels for each dialogue turn.

15. The method of claim 14, wherein the state labels for each dialogue turn include a segment boundary label, a user intent label, and a dialogue domain label for the corresponding dialogue turn, and wherein the segment boundary label indicates whether there is a topical relation between the corresponding dialogue turn and a context of a preceding dialogue turn.

16. The method of claim 15, further comprising:
storing the segmentation prediction including the one or more segments and the user intent and the dialogue domain for each segment.

17. The method of claim 14, wherein generating the structured output based on the segmentation prediction using the state prediction model comprises applying the same user intent and dialogue domain for dialogue turns within the same dialogue segment.

18. The method of claim 14, further comprising:
obtaining a subsequent dialogue turn of the dialogue;
determining whether the subsequent dialogue turn belongs to the same dialogue segment as a preceding dialogue turn based on the segmentation prediction; and
updating the structured output to include a turn summary and state labels for the subsequent dialogue turn.

19. The method of claim 18, wherein determining whether the subsequent dialogue turn belongs to the same dialogue segment as a preceding dialogue turn based on the segmentation prediction comprises determining whether the subsequent dialogue turn is topically related to a context of the preceding dialogue turn based on the segmentation prediction.

20. The method of claim 18, wherein updating the structured output to include a turn summary and state labels for the subsequent dialogue turn comprises:
in response to determining that the subsequent dialogue turn belongs to the same dialogue segment as the preceding dialogue, applying the same state labels for the subsequent dialogue turn as the preceding dialogue turn; and
in response to determining that the subsequent dialogue turn does not belong to the same dialogue segment as the preceding dialogue, determining state labels for the subsequent dialogue turn based on context of one or more proceeding segments of the dialogue and the structured output of one or more proceeding dialogue turns.
